(19) United States
(12) Patent Application Publication
(10) Pub. No.: US 2011/0035743 A1
(43) Pub. Date: Feb. 10, 2011

(54) TESTING DEVICE AND METHOD FOR UPDATING TESTING PROGRAM OF THE TESTING DEVICE

(75) Inventor: SHAO-PU TAO, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/617,959

(22) Filed: Nov. 13, 2009

(30) Foreign Application Priority Data
Aug. 4, 2009 (CN) 200910305191.1

(51) Int. Cl. G06F 9/44; G06F 9/445

(52) U.S. Cl. 717/173; 717/178

(57) ABSTRACT

A testing device communicates with a server, which stores a first testing program and a first update program. The testing device includes a storage unit, a configuration module, a detection module, a judging module, a download module, and an executing module. The storage unit stores a second testing program and a second update program. The configuration module sets a download path. The detection module detects the first program and the first update program. The judging module determines which of the first and second testing programs and which of the first and second update programs is newer. The download module downloads the first update program to the storage unit to replace the second update program when the first testing program and the first update program are newer. The executing module starts the second update program to cause the download module to download the first testing program via the download path.

### BACKGROUND

1. Technical Field

The present disclosure relates to testing devices and methods, and particularly to a testing device and a method capable of updating a testing program.

2. Description of Related Art

Usually, testing programs are stored in testing devices to test items of electronic devices. Therefore, the testing programs should be compatible with the tested items of the electronic devices. However, if the tested items of the electronic devices are changed, the testing programs should be also updated accordingly. It is very inconvenient to update the testing programs in the testing devices one by one.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of a plurality of testing devices communicating with a server via a LAN, in accordance with an embodiment.

FIG. 2 is a block diagram of one testing device and the server of the embodiment of FIG. 1.

FIG. 3 is a flow chart of a process for updating the testing program and the update program of one of the testing devices, in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

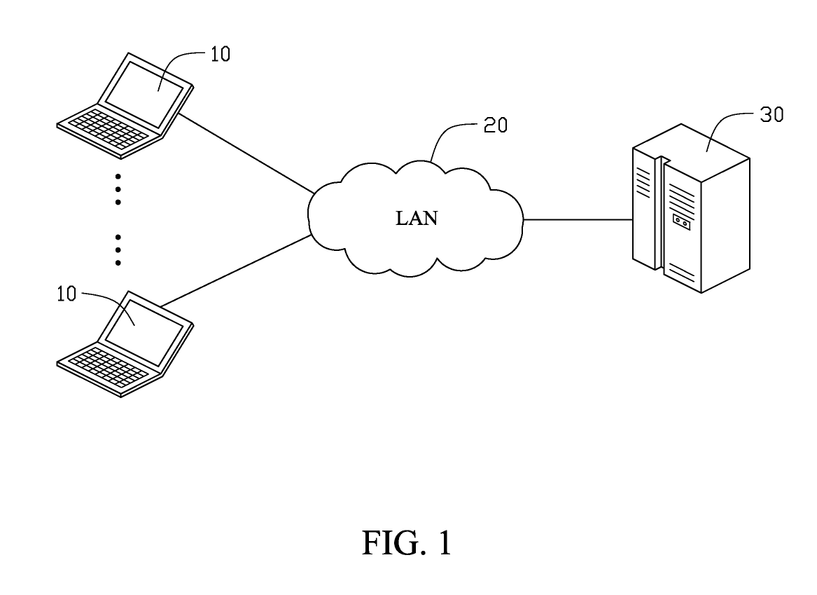

FIG. 1 illustrates a plurality of testing devices 10 coupled to a server 30 via a LAN 20. In one embodiment, the testing device 10 may be a desktop computer, a notebook computer, or other testing devices, for example. The computer 30 may be a notebook computer, a desktop computer, etc., for example.

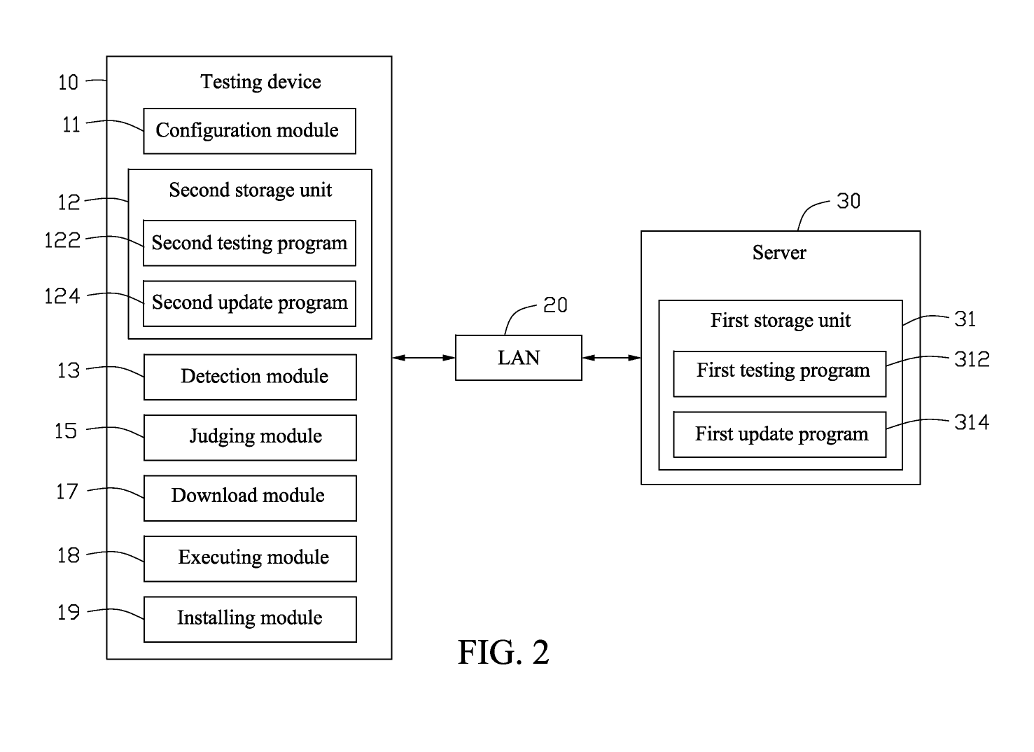

Referring to FIG. 2, the server 30 includes a first storage unit 31. The first storage unit 31 is capable of storing a first testing program 312, a first update program 314, and information of the first testing program 312 and the first update program. The information may include, but not limited to, a creation date and/or a version number.

Each testing device 10 includes a configuration module 11, a second storage unit 12, a detection module 13, a judging module 15, a download module 17, an executing module 18, and an installing module 19. The configuration module 11 is capable of setting a download path, which is directed to the location of the first testing program 312 and the first update program 314. The second storage unit 12 is capable of storing a second testing program 122, a second update program 124, and information of the second testing program 122 and the second update program 124. In one embodiment, the information may include, but not limited to, a creation date and/or a version number.

The detection module 13 is capable of detecting whether the testing program 312 and the update program 314 exist in the storage unit 31 via the download path. The judging module 15 is capable of determining which of the first testing program 312 and the second testing program 122 and which of the first update program 314 and the update program 124 is newer, by the creation date and/or the version number. The download module 17 is capable of downloading the update program 314 from the server 30 via the download path when the first testing program 312 and the update program 314 are newer. The executing module 18 is capable of starting the first update program 314 so as to cause the download module 17 to download the first testing program 312 via the download path. The installing module is capable of installing the first testing program 312 to the testing device 10.

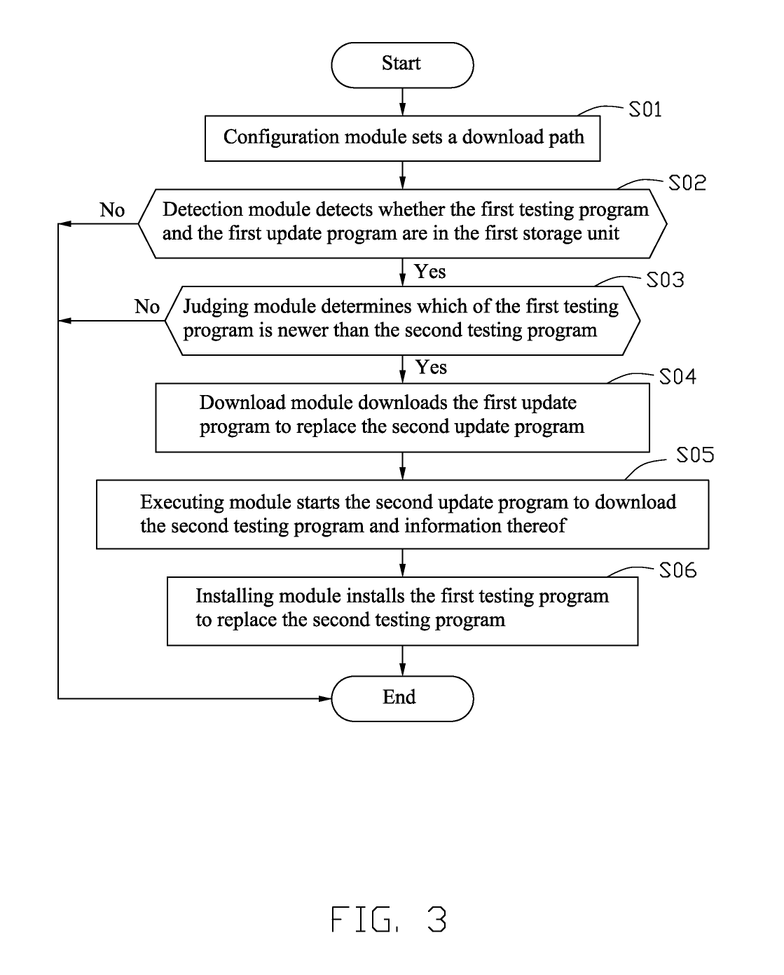

FIG. 3 illustrates a flow chart of a process to update the second testing program 122 of one of the testing devices 10, as an example. The update process includes following steps:

In block S01, the configuration module 11 of the testing device 10 sets a download path.

In block S02, the detection module 13 of the testing device 10 detects whether there is the first testing device 312 and the first update program 314 in the first storage unit 31 of the server 30.

If the first testing device 312 and the first update program 314 isn't detected. The update process goes to end. Otherwise, the update process goes to block S03.

In block S03, the judging module 15 determines which of the first testing program 312 in the first storage unit 31 and the second testing program 12 in the second storage unit 32 is newer.

If the first testing program 312 is newer, the update process goes to block S05. Otherwise, the update process goes to end.

In block S04, the download module 17 of the testing device 10 downs the first update program 314 via the download path to the second storage unit 12 to replace the second update program 124.

In block S05, the executing module 18 starts the second update program 324 so as to cause the download module 17 to download the first testing program 324 via the download path to the second storage unit 12.

In block S06, the installing module 19 installs the first testing program 324 to the testing device 10 to replace the second testing program 324 and information thereof.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

Depending on the embodiment, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A testing device capable of communicating with a server, the server storing a first testing program and a first update program, the testing device comprising:
a storage unit storing a second testing program and a second update program;
a configuration module capable of setting a download path;
a detection module capable of detecting the first program and the first update program via the download path;
a judging module capable of determining which of the first and second testing programs is newer and which of the first and second update programs is newer;
a download module capable of downloading the first update program from the server to the storage unit to replace the second update program when the first testing program and the first update program are newer; and
an executing module capable of starting the second update program so as to cause the download module to download the first testing program to storage unit via the download path.

2. The testing device of claim 1, further comprising an installing module capable of installing the downloaded first testing program in the storage unit to the replace the second testing program.

3. The testing device of claim 1, wherein the judging module is capable of determining which of the first and second testing programs and which of the first and second update programs is newer by the creation dates.

4. The testing device of claim 3, wherein the creation date of the second testing program is stored in the storage unit.

5. The testing device of claim 1, wherein the judging module is capable of determining which of the first and second testing programs and which of the first and second update programs is newer by the reversion numbers.

6. The testing device of claim 5, wherein the reversion number of the second testing program is stored in the storage unit.

7. A method for updating a testing program and an update program of a testing device, the method comprising:
setting a download path by a configuration module of the testing device;
detecting a server testing program and the first update program via a download path by a detection module of the testing device;
determining which of the testing device testing program and the server testing program and which of the testing device update program and the server testing update program is newer by a judging module of the testing device;
downloading the server update program from the server to the storage unit to replace the testing device update program by a download module of the testing device when the server testing program and the server update program are newer; and
starting the testing device update program to cause the download module to download the server testing program to a storage unit by an executing module of the testing device.

8. The method of claim 7, further comprising: installing the downloaded server testing program in the storage unit to the replace the testing device testing program by an installing module of the testing device.

9. The method of claim 7, wherein the judging module determines which of the server testing program and the testing device testing programs and which of the server update program and the testing device update program is newer by the creation dates.

10. The method of claim 7, wherein the judging module determines which of the server testing program and the testing device testing program and which of the server update program and the testing device update programs is newer by reversion numbers.

11. A method for updating a first testing program and a first update program of a server to a testing device, the testing device storing a second testing program and a second update program, the method comprising:
setting a download path by a configuration module of the testing device;
detecting the first testing program and the first update program via a download path by a detection module of the testing device;
determining which of the first and second testing programs and which of the first and second update programs is newer by a judging module of the testing device;
downloading the first update program from the server to a storage unit to replace the second update program by a download module of the testing device when the first testing program and the first update program are newer; and
starting the second program to cause the download module to download the first testing program to storage unit by an executing module of the testing device.

12. The method of claim 11, further comprising: installing the downloaded first testing program in the storage unit to the replace the second testing program by an installing module of the testing device.

13. The method of claim 11, wherein the judging module determines which of the first and second testing programs and which of the first and second update programs is newer by the creation dates.

14. The method of claim 13, wherein the creation date of the second testing program is stored in the storage unit.

15. The method of claim 11, wherein the judging module determines which of the first and second testing programs and which of the first and second update programs is newer by reversion numbers.

16. The method of claim 15, wherein the reversion number of the second testing program is stored in the storage unit.
